(19) United States
(12) Patent Application Publication
(10) Pub. No.: US 2012/0256442 A1
(43) Pub. Date: Oct. 11, 2012

(54) SUN PROTECTION APPARATUS FOR AUTOMOBILE DRIVER OR PASSENGER

(76) Inventor: Rochit Rajsuman, San Jose, CA (US)

(21) Appl. No.: 13/084,138

(22) Filed: Apr. 11, 2011

(51) Int. Cl. B60J 3/00

(52) U.S. Cl. 296/97.8

(57) ABSTRACT

An automotive window visor and variations are disclosed. The visor is pivotably mounted or mountable to the interior of an automobile. In an extended or an open position, the visor provides shade at a side window of the automobile. First and second embodiments include an extendable section that folds or slides out from a base section to an extended position. The extendable section fold or slides back to the base section to a compact position. More shade is provided with the extendable section in the extended position than in the compact position. The third embodiment includes a shade member and a hinge. The shade member pivots downward to an open position to provide shade over a portion of a front side window. The shade member pivots upward to a closed position. The shade member may further pivot rearwardly at the hinge to provide shade at a rear side window.

### TECHNICAL FIELD

The field of the present invention relates to automobiles and more specifically to window visors for automobiles.

### BACKGROUND

Today, automobiles are usually equipped with a pair of front or windscreen visors each of which can provide an amount of shade. Driving in an East bound direction in the morning or a West bound direction in the afternoon, the driver and front seat passenger can each lower a respective visor and create a shade. The length of each windscreen visor is less than or up to close to one-half of the width of the upper span of the front windshield. Thus, each windscreen visor is suitable for one person. Most automobiles also allow each visor to swing towards the respective side window. However, when swung towards the side window, the windscreen visor only covers the corner of the side window closest to the front windshield. Generally, the visors are of an opaque material.

When driving in a North bound direction or a South bound direction, the Sun may shine on side windows. To avoid intense heat and light, some drivers hang a towel, a piece of cloth or other covering in the window by clamping it with the side window's glass. While this covering provides shade by blocking the Sun, it creates a safety hazard because the covering may also block too much of the driver's left side view.

The front seat passenger also suffers in a similar manner. Hanging a towel or a piece of cloth on the passenger side window is likewise a safety hazard as it blocks the driver's right side view.

### SUMMARY

An extendable automotive window visor and variations are disclosed. The automotive window visor is a Sun protection apparatus for automobile drivers and passengers. The first and second embodiments of the automotive window visor are of a type that pivots to cover a portion of the front windshield or pivots to cover a portion of a side window of the automobile. The third embodiment of the automotive window visor is of a type that can cover a portion of a side window of the automobile.

In a first embodiment, the automotive window visor has a base section and a foldable extension that is an extendable section. The base section is pivotably mountable to the interior of an automobile proximate to an upper corner of the front windshield of the automobile. The extension folds out from the base section to an extended position and folds back upon the base section to a compact position. The base section and the extendable section in the compact position provide shading across a portion of the front windshield or across a portion of a side window of the automobile. The base section and the extendable section in the extended position provide shading across more than the portion of the side window.

In a second embodiment, the automotive window visor has a base section and a slidable extension that is an extendable section. The base section is pivotably mountable to the interior of an automobile proximate to an upper corner of the front windshield of the automobile. The extension slides out from the base section to an extended position and slides back into the base section to a compact position. The base section and the extendable section in the compact position provide shading across a portion of the front windshield or across a portion of a side window of the automobile. The base section and the extendable section in the extended position provide shading across more than the portion of the side window.

In a third embodiment, an automotive side-window visor has a shade member and a hinge. The hinge attaches the shade member to the roof of the automobile in the interior of the automobile. The shade member pivots downward to an open position to provide shade over a portion of a front side window of the automobile. The shade member further pivots upward to a closed position.

The extendable section and a folding mechanism or a sliding mechanism may be provided as a kit, as may the shade member and a hinge.

### BRIEF DESCRIPTION OF THE DRAWINGS

FIG. 1 is an elevated view of an automotive window visor with a foldable extension in an extended position, in accordance with a first embodiment of the present invention.

FIG. 2 is an elevated view of the automotive window visor of FIG. 1, with the extension in a folded position.

FIG. 3 is an elevated view of an automotive window visor with an extension that slides to an extended position, as a variation of the automotive window visor of FIG. 1.

FIG. 4 is an elevated view of an automotive side-window visor that can pivot, as a variation of the automotive window visor of FIG. 1.

### DETAILED DESCRIPTION

Today, automobiles don't have a shade or visor over the entire width of the driver or passenger side windows. In the morning when driving on a South bound road or in the afternoon when driving on a North bound road, the Sun shines directly on the driver's window. The Sun warms the left side of the face and arm of the driver. Similarly, the Sun warms the right side of the face and arm of the front seat passenger. It is not only inconvenient but also hampers the driver to look outside the window, into the glare of the sunlight. The heat and intense light not only warms up the left side of the face and arm, it hampers a driver's ability to check traffic on the left side. A standard automotive window visor may pivot and provide partial shading, but additional shading is desired and is provided by the disclosed automotive window visor.

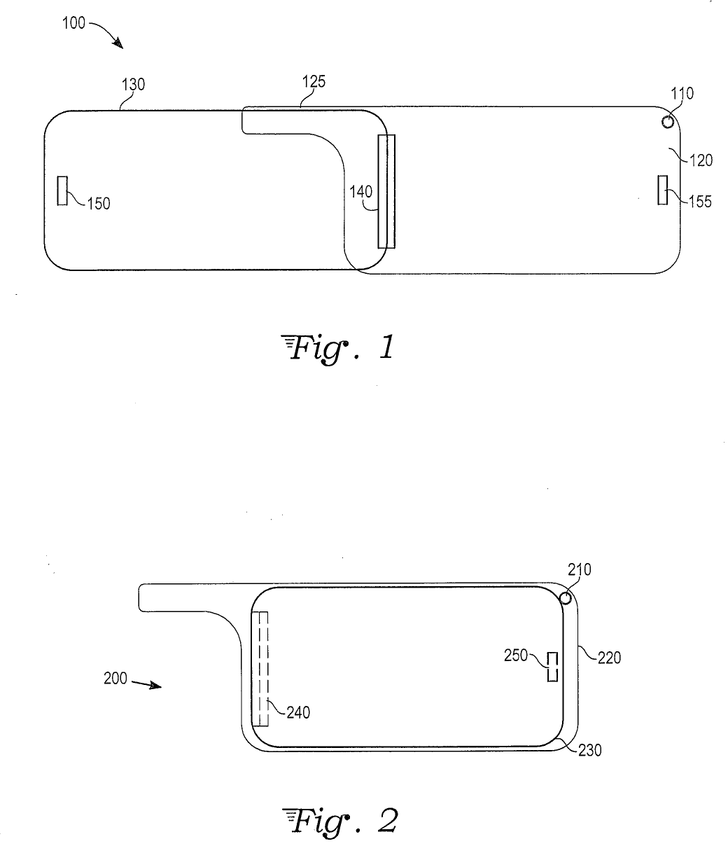

With reference to FIG. 1, an automotive window visor 100 with a base section 120 and an extendable section 130 is disclosed that provides shade to the driver or the passenger when the Sun is shining directly at the respective side window. The base section 120 has dimensions and shape similar to a standard automotive front windshield visor, and has fittings for attachment and operation of the extendable section 130.

The present day automotive window visor is well-known. Because of interior width or space limitation, a longer fixed-length windscreen visor than the standard visor is not advisable. As can be seen from FIG. 1, the length of the base section 120 and thus the length of a similar standard visor is at maximum possible length, and any further length will block the rear-view mirror. In fact, the shape of the base section 120 is already narrowed to a tapered section 125 to accommodate the rear-view mirror, as is a standard visor.

Although a standard visor is the maximum possible fixed length, the standard visor is not suitable to provide shade over the entire width of a side window or even the majority thereof. When the standard visor is swung towards the respective side window, the standard visor covers only the corner of the side window, and the remainder of the window remains un-shaded.

Various embodiments of an extendable automotive window visor are herein disclosed. Each embodiment can be extended over the side window, creating a shade without blocking the view of the driver or passenger. Each embodiment may have advantages or disadvantages, but all embodiments provide additional shade over the respective window as compared to the standard visor.

In a first embodiment as shown in FIG. 1, the new visor 100 contains an extendable section 130 that when extended provides a shade over the respective side window. The extendable section 130 is foldable at a hinge 140, which can be a living hinge, a metal hinge, a plastic hinge or other type of hinge readily devised. In the extended position, as depicted in FIG. 1, the extendable section 130 and the base section 120 provide shade across a greater portion of the respective side window than does the base section 120 alone. FIG. 1 shows the extendable section 130 and the base section 120 providing shade at the front seat left-side window. A pivotable mounting 110 of the base section 120 allows the base section 120 to move as would a standard visor, such that the base section 120 can provide shade at the front windshield or provide shade at the side window, or fold flat against the automobile roof liner. The extendable section 130 can be secured to the base section 120 with a fastening device, such as a first fastening device 150 attached to the extendable section 130 and/or a second fastening device 155 attached to the base section 120.

In the compact folded position as shown in FIG. 2, the extendable section 230 is folded at the hinge 240, doubles-over the base section 220 and is secured via a clamp, or a hook and loop (e.g. Velcro™) or other fastening device 250. Other possible mechanisms for fastening the folded section are using a magnet and plate or magnets, a press-on button, complementary snaps, a hook and so on. Because the extendable section 230 is doubled-over the base section 220 when folded, the extendable section 230 doesn't block the rear-view mirror or cause any ill-effect in the folded position.

When the visor 100 is swung toward the side window, the user can unfold and extend the extendable section 130 effectively doubling the length of the original visor. Thus, the new visor 100 with the extendable section 130 unfolded to the extended position of the visor 200 provides shade over the side window. As the visor 100 or 200 only covers the top part of the side window, the new visor doesn't block the driver's view.

This design has a potential drawback. When the extension is employed and the window is open, because of the moving automobile, the extension faces high wind. Unless a stiff lock-in mechanism is used, the high-wind forces the extension to fold back. Thus, practical versions of the first embodiment have a fastening device of sufficient strength to secure the extendable section in a folded condition in a moving automobile, traveling at highway speed with an open window. When the extendable section is attached on the backside of the base section, the base section provides partial support and reduces this drawback.

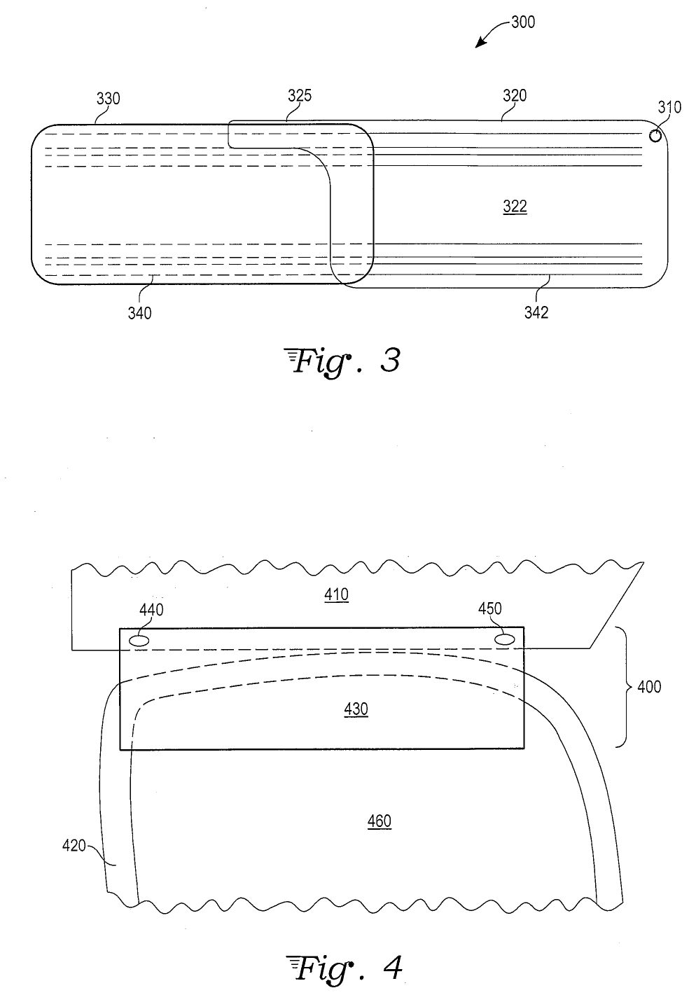

To overcome the drawback of the foldable-extension design, a second embodiment is presented. The second embodiment, shown as the visor 300 in FIG. 3, includes an extension or extendable section 330 that can slide, instead of folding as in the first embodiment. The sliding mechanism can be sliding rails 340, 342 or concentric extendable tubes such as used in an antenna. Various forms of single or multiple sliding rails are readily devised by a person skilled in the art. Various sliding, concentric, telescoping tube mechanisms are readily devised by a person skilled in the art in accordance with the disclosure, and can be singly or multiply segmented. One or more inner or outer sliding rails 340 or one or more inner or outer telescoping tubes can be attached to or formed integrally with the extendable section 330, with a complementary one or more outer or inner sliding rails 342 or one or more outer or inner telescoping tubes attached to or formed as part of the base section 322. The extendable section 330 and the sliding mechanism can be built such that the extendable section 330 can be housed inside the original visor or such that the extendable section 330 is an add-on to the outside. Each or both of the extendable section 330 and the base section 322 can be opaque to completely block light, or they can be a darkened translucent or transparent material.

In the second embodiment as shown in FIG. 3, the standard visor 320 is modified to include a first set of sliding rails 342, and acts as a base section 322. The extendable section 330 includes a complementary set of sliding rails 340 that mate with and slide along the sliding rails 342 on the modified standard visor 320. A pivotable mounting 310 of the standard visor 320 or of the base section 322 allows pivoting movement of the visor 300. Such pivotable mountings are known and readily devised by a person skilled in the art.

In versions where the extendable section 330 deploys from inside of the base section 322, the majority or all of the extendable section 330 is inside the base section 322 in a compact position. The extendable section 330 slides out from within the base section 322 to the extended position. In such versions, a portion of a sliding mechanism, such as a sliding rail 342 or a telescoping tube is mounted inside the base section 322. A complementary portion of the sliding mechanism, such as a sliding rail 340 is attached to or formed integrally with the extendable section 330. In one version, a telescoping tube is inside the extendable section 330 and a complementary telescoping tube is inside of the base section 322. The telescoping tube and the complementary telescoping tube slide one within the other or one outside of the other, to deploy and stow the extendable section 330.

In versions where the extendable section 330 deploys from a position outside of the base section, the majority or all of the extendable section 330 is external to the base section 322 in both the compact position and the extended position. The extendable section 330 slides out from a position in close proximity to and adjacent to the base section 322, to the extended position. In such versions, a portion of a sliding mechanism, such as a sliding rail 340 or a telescoping tube, is attached to the outside of the extendable section 330 or formed integrally with the extendable section 330.

An entire visor 100, 200 or 300 with an extendable section 130, 230 or 330 can be packaged and sold as an assembly or provided as an original equipment manufacturer assembly, or portions thereof may be packaged and sold as a kit. As an example, the extendable section 330 and a sliding mechanism can be provided as a kit, with a portion of the sliding mechanism being attached to or integral with the extendable section 330 and a complementary portion of the sliding mechanism being attachable to the original standard visor 320 to form a base section 322. Similar kits can be devised for variations that fold, roll or otherwise deploy with various mechanisms or have various fasteners.

In the first and second embodiments, the existing standard visor has been improved and modified with an extension that provides shade over the window. An alternative solution is shown in FIG. 4 as a third embodiment that has a dedicated visor 400 over the side window 460. This dedicated visor 400 can be fixed to the interior at the roof 410 of the car and can be lowered when shade is needed. One disadvantage of the dedicated window visor 400 is that it incurs an additional cost to the car maker. To add the dedicated window visor 400 to an automobile requires not only an additional part but also a slight modification in the roof of the car, as by adding hinges 440 and 450. The additional cost includes the additional part, namely the visor 400 itself, and the fixed hinges 440, 450 in the roof of the car through which this dedicated visor 400 is attached. It should be noted that a dedicated window visor can also be employed at back seat windows.

The visor 400 includes a shade member 430 and one or two hinges 440, 450. The shade member 430 lowers and raises by pivoting downward and upward at the hinge 440 or at the hinge 440 and the hinge 450.

In one design of the third embodiment as shown in FIG. 4, two hinges 440, 450 are used, one each at the upper left-hand and upper right-hand corner. The shade member 430 can be folded upwards to a closed position at the roof liner of the automobile when not in use. An alternative is to hinge the shade member 430 only at one upper corner with the hinge 440 as a pivoting hinge attached to the roof 410 of the car near the upper back corner of the doorframe 420 of the car, allowing the shade member 430 to swing either to the front side window 460 or to the rear seat side window. From either position, at the front side window or the rear side window, the shade member 430 can be folded upwards to a closed position or downwards to an open position. A further alternative is to use a pivoting hinge for the hinge 440 at a rearward end of the shade member 430 and a releasable hinge for the hinge 450 at a frontward end of the shade member 430.

Multiple embodiments and variations are disclosed that provide shade over the window without blocking the driver's view. The embodiments have trade-offs in terms of cost, number of parts and implementation. However, each embodiment provides shade and comfort to the driver or passenger when the Sun is shining directly at the window. Embodiments described as on the driver's side can be readily reversed for use for the front seat passenger side, providing shade and comfort to the passenger. Embodiments described as on the passenger's side can be readily reversed for use for the driver side. Such reversal can be in the form of mirror-image assemblies, or a single assembly that is itself symmetric and/or reversible.

What is claimed is:

1. An automotive window visor comprising:
a base section, pivotably mountable to an interior of an automobile proximate to an upper corner of a front windshield of the automobile; and
an extendable section that folds out from the base section to an extended position and folds back to the base section to a compact position;
wherein:
the base section and the extendable section in the compact position provide shading across a portion of the front windshield or across a portion of a side window of the automobile; and
the base section and the extendable section in the extended position provide shading across more than the portion of the side window.

2. The automotive window visor of claim 1 wherein the base section in the extendable section are opaque.

3. The automotive window visor of claim 1 further including a hinge that attaches the extendable section to the base section.

4. The automotive window visor of claim 1 further including a fastening device that secures the extendable section to the base section in the compact position.

5. The automotive window visor of claim 4 wherein a first portion of the fastening device is attached to the extendable section and a second portion of the fastening device is attached to the base section.

6. The automotive window visor of claim 4 wherein the fastening device includes at least one magnet.

7. The automotive window visor of claim 4 wherein the fastening device includes a hook and loop fastener, a press-on button or a snap-on fitting.

8. The automotive window visor of claim 1 wherein the extendable section, a folding mechanism and a fastening device are provided as a kit, with the folding mechanism being attachable to the base section and attachable to or attached to the extendable section and with the fastening device being operable to secure the extendable section to the base section in the compact position.

9. An automotive window visor comprising:
a base section, pivotably mountable to an interior of an automobile proximate to an upper corner of a front windshield of the automobile; and
an extendable section that slides out from the base section to an extended position and slides back to the base section to a compact position;
wherein:
the base section and the extendable section in the compact position provide shading across a portion of the front windshield or across a portion of a side window of the automobile; and
the base section and the extendable section in the extended position provide shading across more than the portion of the side window.

10. The automotive window visor of claim 9 wherein the base section and the extendable section are opaque.

11. The automotive window visor of claim 9 wherein the base section and the extendable section have complementary sliding rails that engage to slide the extendable section out from and back to the base section.

12. The automotive window visor of claim 9 wherein the base section and the extendable section have telescoping tubes that engage to slide the extendable section out from and back to the base section.

13. The automotive window visor of claim 9 wherein a majority of the extendable section is inside the base section in the compact position and the extendable section slides out from within the base section to the extended position.

14. The automotive window visor of claim 9 wherein a majority of the extendable section is external to the base section in the compact position and in the extended position.

15. The automotive window visor of claim 9 wherein the extendable section and a sliding mechanism are provided as a kit, with the extendable section having a first portion of the sliding mechanism and with a second portion of the sliding mechanism being attachable to the base section such that the first and second portions of the sliding mechanism engage to slide the extendable section out from and back to the base section.

16. An automotive side-window visor in an automobile, the visor comprising:
a shade member; and
a hinge attaching the shade member to a roof in an interior of the automobile such that the shade member pivots downward to an open position to provide shade over a portion of a front side window of the automobile and the shade member pivots upward to a closed position.

17. The automotive window visor of claim 16 wherein the shade member further pivots rearwardly at the hinge to provide shade at a portion of a rear side window of the automobile.

18. The automotive window visor of claim 17 wherein the hinge is a first hinge and further including a second hinge releasably attaching the shade member to the roof in the interior of the automobile such that the shade member is releasable from the second hinge to pivot rearwardly at the first hinge.

19. The automotive window visor of claim 16 wherein the hinge is a first hinge and further including a second hinge attaching the shade member to the roof in the interior of the automobile.

20. The automotive window visor of claim 16 wherein the shade member and the hinge are provided as a kit.
